(19) United States
(12) Patent Application Publication
(10) Pub. No.: US 2014/0180918 A1
(43) Pub. Date: Jun. 26, 2014

(54) STORED-VALUE CARD SYSTEM

(71) Applicants: John Ekers, Plymouth, MN (US); Keith Goldstein, Framingham, MA (US); Rich Eicher, JR., Windham, NH (US)

(72) Inventors: John Ekers, Plymouth, MN (US); Keith Goldstein, Framingham, MA (US); Rich Eicher, JR., Windham, NH (US)

(21) Appl. No.: 14/132,875

(22) Filed: Dec. 18, 2013

Related U.S. Application Data
(60) Provisional application No. 61/738,674, filed on Dec. 18, 2012.

(51) Int. Cl. G06Q 20/10; G06Q 20/34

(52) U.S. Cl. CPC G06Q 20/105; G06Q 20/342
USPC 705/41

(57) ABSTRACT

A hybrid stored-value card system is designed to support and effectively link uniquely designed physical stored-value cards with digital stored-value cards. Each physical stored-value card is preferably provided with a unique mobile link code that can be retrieved by a mobile device using automated means of data capture. The link code is transmitted to a server in direct communication with the mobile device along with certain pre-defined user information, such as the card owner name, email address and mobile number. The server utilizes the link code to create a corresponding digital stored-value card that can be downloaded and installed onto the mobile device in a format and design as specified by the card issuer. Using the user information, the server is able to maintain a direct communication path with the mobile device and thereby provide real-time notifications and updates to the card owner.

### FIELD OF THE INVENTION

The present invention relates generally to the transaction card industry and, more particularly, to stored-value cards.

### BACKGROUND OF THE INVENTION

A stored-value card is a transaction card provided with a certain amount of currency that is typically retained and accessed either (i) directly on the card or (ii) through an externally managed system (stored-value cards that rely upon an externally managed system for handling the currency being commonly referred to as “prepaid cards” in the industry). In this manner, a stored-value card can be used as currency at a point-of-sale (POS) when engaging in a financial transaction. As part of the transaction process, the currency balance associated with the card is decremented based on the value of the purchase.

Commonly, a card reader is utilized at the point-of-sale to access the currency available on the card. Reading of the card is typically achieved using an automated means of data capture, such as technologies that rely on the use of magnetic stripes, barcodes, radio frequency identification (RFID), or near-field communication (NFC) to automatically retrieve data.

Presently, stored-value cards are utilized in a wide variety of applications. For instance, stored-value cards are commonly utilized as, among other things, gift cards, transit cards and calling cards.

Stored-value cards are also designed for use in a variety of different purchasing environments. For instance, in a closed system, a stored-value card is designed for use with a single specified vendor (e.g., a particular retail store). By comparison, in a semi-closed system, a stored-value card is designed for use with a plurality of selected vendors (e.g., with certain retail stores in a particular shopping mall). Lastly, in open system, a stored-value card is designed for use with an unlimited number of different vendors (e.g., with any retail store that supports a particular brand of credit card).

Stored-value cards are generally formed as either of two types—physical or electronic. As will be described further below, physical stored-value cards and electronic stored-value cards traditionally operate independently of one another. Because the two basic types of stored-value cards are not linked, or otherwise interconnected, in any fashion, the card owner is restricted from transferring currency available with one type of stored-value card to the other type of stored-value card, which is highly undesirable.

A physical stored-value card is generally constructed as a plastic transaction card, typically the size of a conventional credit card, which is provided with means for electronically storing data that is used to access the currency associated with the card. As such, a physical stored-value card is commonly utilized in the following manner. Specifically, the card is manufactured and applied with a unique identification code using a medium suitable for automated, or machine-readable, data capture (e.g., a barcode, magnetic stripe, or embedded integrated circuit (IC) chip). For security purposes, the physical stored-value card is typically displayed at the point-of-sale with a zero currency balance. Accordingly, as part of the process of activating the card at the POS, the unique identification code is automatically retrieved by the vendor and the funds to be applied to the card are purchased. As part of the financial transaction, the funds are associated with the card by the vendor, preferably using the same medium of automated data capture as the unique identification code (e.g., as binary-coded data stored onto a magnetic stripe). When the card is to be used at the point-of-sale as part of a sales transaction, the funds associated with the card are accessed through the automated data capture medium and are decremented according to the price of the transaction.

Although well-known and widely used in commerce, physical stored-value cards of the type as described above have been found to suffer from a notable drawback. Specifically, the use of stored-value cards remains largely anonymous. In other words, the card issuer does not acquire and retain any useful information relating to the user of the card (e.g., contact information or historical shopping patterns) for future promotional and marketing purposes.

An electronic stored-value card (also commonly referred to in the art as a mobile stored-value card or a digital stored-value card) functions similarly to a physical stored-value card with the notable exception being that the currency balance, or card value, associated with the card is accessed at the point-of-sale using a mobile device rather than a physical transaction card. The creation of an electronic stored-value card is typically achieved through a direct electronic exchange between the mobile device and a server for the card issuer (e.g., through a short message service (SMS) exchange).

Specifically, as the first step in the electronic card generation process, the user initiates card activation by electronically connecting to a server that is maintained either by the card issuer or an authorized third party service provider (e.g., by sending a text message or by clicking on a link embedded in an electronic offer sent by the server to the user). As an optional subsequent step, the server may request the user to provide personal information as part of the card redemption process. Thereafter, the server electronically transmits the digital currency to the user in the form of a mobile stored-value card. Once received and confirmed by the user, the electronic stored-value card is typically accessed through a designated software application on the mobile device, with the funds accessible for use at the point-of-sale using any viable means of automated data capture (e.g., NFC technology).

In this capacity, the software application enables the mobile device to function as a digital, or electronic, wallet that can be used to store and organize a variety of prepaid items, such as gift cards, travel tickets, phone cards, and the like. The application typically displays the digital stored-value card in the designated software application in a format specifically designed by the issuer, the card including certain non-variable data (e.g., a standard background with color images and a stylized logo) as well as certain card-specific, variable data (e.g., a currency balance, expiration date, etc.).

Electronic stored-value cards of the type as described above have been found to provide a number of notable advantages.

As a first advantage, electronic stored-value cards provide greater accessibility to the user. In particular, due to the ubiquitous nature of mobile devices, the user is more likely to carry the card and, as such, is more readily prepared to use the card. By contrast, it has been found that users do not similarly carry physical stored-value cards on a daily basis, but rather, retrieve the physical card when embarking on a predetermined shopping trip.

As a second advantage, electronic stored-value cards enable a card issuer to directly connect and interact with the card user. Accordingly, the card issuer can transmit, in real-time, pertinent updates and notifications to the user. For instance, card-specific data can be adjusted in real-time to reflect a particular transaction (e.g., the currency balance associated with a card can appropriately decremented after a purchase). Similarly, alerts can be sent by the card issuer to notify the user of certain relevant conditions (e.g., when the balance meets a particular minimum threshold or when the expiration date is deemed imminent).

As a third advantage, electronic stored-value cards enable a card issuer to retain certain useful information relating to the card user (e.g., the name, age, and transaction history of the user). As can be appreciated, the card issuer can utilize collected personal information for marketing purposes to drive sales growth through the promotion of future campaigns (e.g., to send an alert to certain users when a particular sale is scheduled to commence).

As a fourth advantage, electronic stored-value cards are often designed for use interchangeably across multiple mobile devices, thereby increasing the card availability and likelihood of frequent usage.

Even though electronic stored-value cards provide a number of useful benefits, some of which are set forth in detail above, physical stored-value cards are still widely used in commerce. Furthermore, there is presently no adequate means for physical stored-value cards to derive the benefits and advantages associated with the use of electronic stored-value cards. Rather, as noted briefly above, physical stored-value cards and electronic stored-value cards typically operate within two entirely independent transaction card systems.

### BRIEF SUMMARY OF THE INVENTION

It is an object of the present invention to provide a new and improved stored-value card system.

It is another object of the present invention to provide a new and improved stored-value card system that supports the use of both physical stored-value cards and electronic stored-value cards.

It is yet another object of the present invention to provide a stored-value card system of the type as described above which provides access to a currency balance interchangeably across both physical and electronic stored-value card formats.

It is still another object of the present invention to provide a stored-value card system of the type as described above which is inexpensive to implement and easy to use.

Accordingly, as one feature of the present invention, there is provided a hybrid stored-value card system comprising (a) a digital stored-value card system, and (b) a physical stored-value card system that is selectively electronically linked with the digital stored-value card system, the physical stored-value card system including a physical stored-value card, (c) wherein the digital stored-value card system is adapted to transform the physical stored-value card into a corresponding electronic stored-value card, the corresponding electronic stored-value card being integrated into the digital stored-value card system.

As another feature of the present invention, there is provided a method of converting a physical stored-value card into a corresponding electronic stored-value card, the method comprising the steps of (a) providing a physical stored-value card that includes a unique mobile link code, (b) retrieving the unique mobile link code from the physical stored-value card using a mobile device, (c) transmitting the unique mobile link code from the mobile device to a server in electrical communication therewith, (d) transforming the physical stored-value card into an electronic stored-value card by the server using the unique mobile link code, and (e) sending the electronic stored-value card from the server to the mobile device.

Various other features and advantages will appear from the description to follow. In the description, reference is made to the accompanying drawings which form a part thereof, and in which is shown by way of illustration, various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is simplified block diagram of a stored-value card system constructed according to the teachings of the present invention;

FIG. 2 is a sample data table stored in the database shown in FIG. 1; and

FIGS. 3(a)-(d) are a series of sample screen displays that are useful in understanding the process of converting a physical stored-value card into a digital stored-value card within the system shown in FIG. 1.

### DETAILED DESCRIPTION OF THE INVENTION

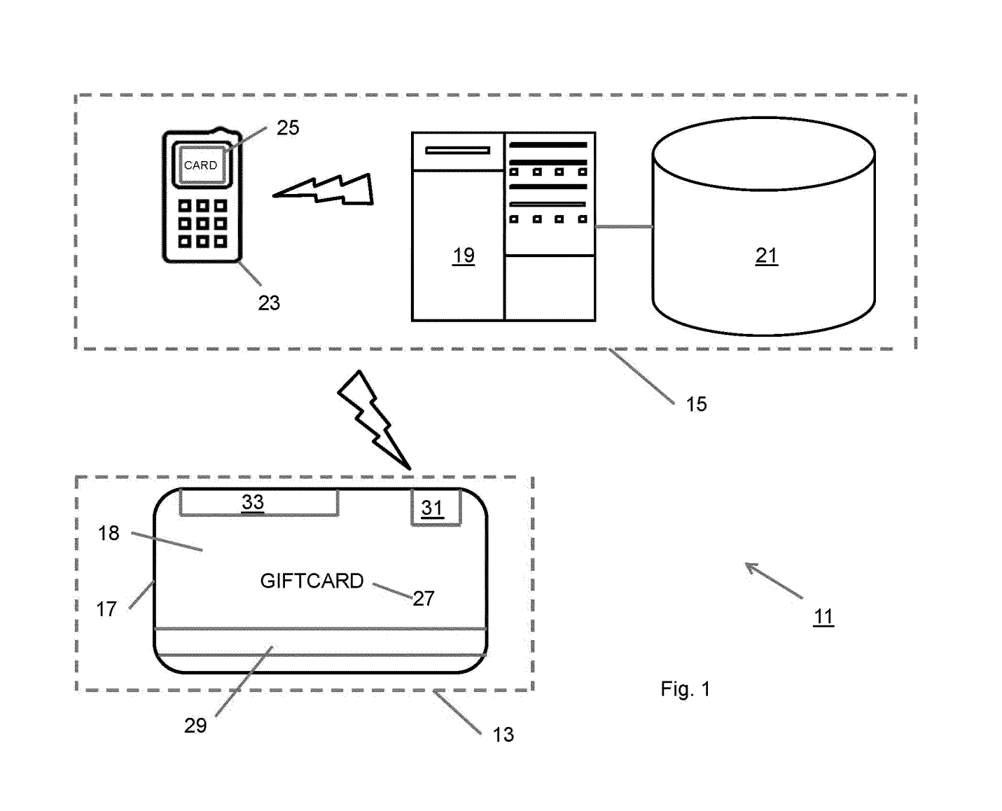

Referring now to FIG. 1, there is shown a stored-value card system constructed according to the teachings of the present invention, the stored-value card system being identified generally by reference numeral 11. As will be described further in detail below, system 11 is designed to both support and effectively link physical stored-value cards with electronic stored-value cards. As a result, a physical stored-value card can be transformed, or otherwise integrated, into an electronic stored-value card system, which is a principal novel feature of the present invention.

### Stored-Value Card System 11

Stored-value card system 11 comprises a physical stored value card system 13 that is electronically linked with a digital, or electronic, stored-value card system 15. In this capacity, system 11 operates as a hybrid stored-value card system that supports the use of both physical and digital stored-value cards, which is a principal object of the present invention.

Physical stored-value card system 13 comprises at least one physical stored-value card 17. As will be described in detail below, each card 17 is provided with a novel code that allows for its digital transformation and integration into digital stored-value card system 15.

Digital stored-value card system 15 comprises a card management, or hub, server 19 that, inter alia, controls the process of electronically linking physical stored value card system 13 with digital stored-value card system 15. Server 19 is electronically connected to a storage device, or database, 21 that retains relevant card data.

Although not shown herein, it is to be understood that server 19 and database 21 could be commonly located and maintained within a centralized facility that is primarily responsible for the management of physical and digital stored-value cards for various card issuers.

Digital stored-value card system 15 additionally includes at least one mobile device 23 in electronic communication with server 19. Mobile device 23 represents any type of mobile compute device, such as a smartphone or tablet, which is programmed with a software application that supports the storage and use of at least one digital stored-value card 25.

### Physical Stored-Value Card 17

Physical stored-value card 17 is similar to a traditional transaction card in that the card includes a card body 18 that is preferably formed out of plastic (or another suitable material) in the general shape of a credit card. Card body 18 is preferably provided with, among other things, certain non-modifiable components 27 (e.g., stylistic components, such as a colored or patterned background, the name of the card issuer in a particular font and/or images).

Card 17 is also provided with a primary device 29 suitable for storing data in a format that can be automatically captured using a complimentary mechanical reader. For instance, in the present embodiment, primary device 29 is represented as a magnetic stripe that is adapted to store data that can be automatically captured by a complimentary magnetic stripe card reader.

However, it should be noted that primary device 29 is not limited to the use of a magnetic stripe for storing machine-readable data. Rather, it is to be understood that device 29 could be in the form of alternative types of machine-readable data storage devices, such as a barcode or an IC chip adapted to support communication using RFID or NFC technology, without departing from the spirit of the present invention.

As will be described further in detail below, primary device 29 is preferably designed to retain a first set of data relating to card 17 that includes, inter alia, an account number for uniquely identifying card 17. The first set of data stored on primary device 29 may additionally include the real-time currency balance of card 17 upon activation (i.e., for cards designed to retain the currency balance directly on the card). In turn, it should be noted that the card account number may be cross-referenced within database 21 with additional information relating to the particular construction, or type, of card 17 (e.g., whether card 17 supports direct contact, contactless or hybrid RFID communications).

Card 17 differs primarily from a traditional physical stored-value card in that card 17 includes a secondary device 31 suitable for storing data in a format that can be automatically captured using a complimentary mechanical reader. In the present embodiment, secondary device 31 is in the form of a quick read, or QR, barcode that is provided in a corner of card 17, with secondary device 31 being separate from primary device 29.

It is to be should be noted that secondary device 31 is not limited to QR-type barcode for storing machine-readable data. Rather, it is to be understood that secondary device 31 could be in the form of alternative types of machine-readable data storage devices, such as an IC chip adapted to support communication using RFID or NFC technology, without departing from the spirit of the present invention.

It should also be noted that secondary device 31 need not be located directly on card 17, but rather, could be provided on a separate carrier or additional card body that is removably attached to card 17 without departing from the spirit of the present invention.

Secondary device 31 is preferably designed to store, inter alia, a second set of data that includes, inter alia, a unique, mobile link code, or tag, that can be used to convert physical card 17 into a corresponding digital stored-value card 25 on mobile device 23, as will be described further in detail below.

In the present embodiment, the above-identified first set of data is stored on primary device 29 and the above-identified second set of data is stored on secondary device 31. In this capacity, previously constructed physical stored-value cards (i.e., cards without a mobile link code) can be adapted for use within hybrid system 11 by simply adding secondary device 31 as part of a subsequent manufacturing step.

However, it is to be understood that all data associated with card 17, namely, the first and second sets of data referenced above could be stored on a single data storage device without departing from the spirit of the present invention.

Card 17 is additionally preferably provided with a scratch panel 33 that, when removed, displays a random PIN code, or password. As can be appreciated, the PIN code would provide additional security and thereby ensure that the digital conversion of card 17 is limited to the individual in its physical possession.

It should be noted that, in place of scratch panel 33, the PIN code may be alternatively provided to the user electronically during the digital card conversion process.

### Database 21

As referenced briefly above, database 21 is designed to store data for hybrid system 11 that readily enables conversion of traditional physical stored-value cards 17 into corresponding digital stored-value cards 25. As will be described further below, database 21 preferably stores, inter alia, the unique card account number, the currency balance, and the mobile link code associated with each physical card 17.

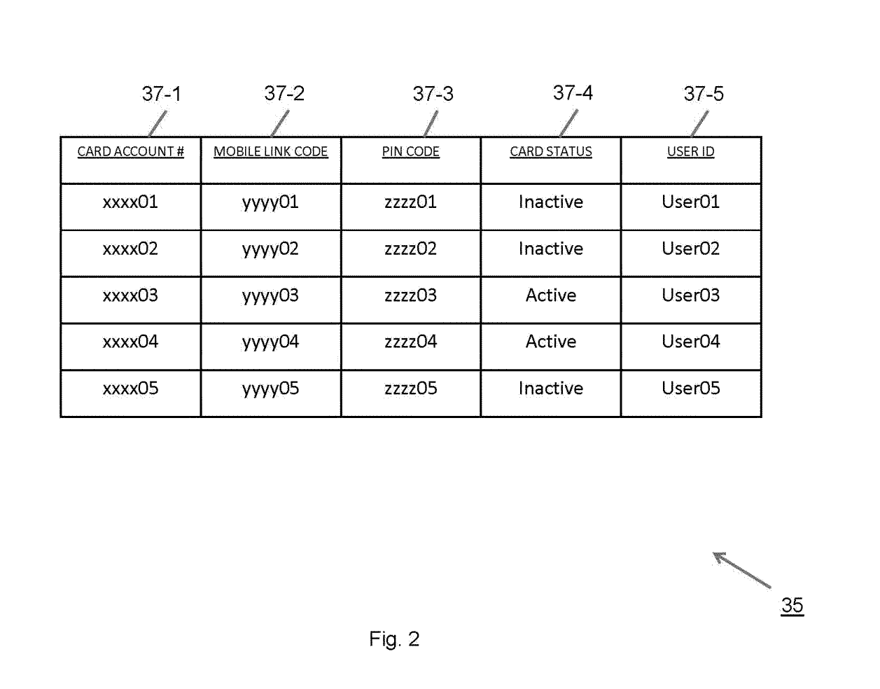

Referring now to FIG. 2, there is shown a sample data table 35 that is stored in database 21 and that is used, among other things, to cross-reference the pertinent data relating to each card in system 11. As can be seen, sample data table 35 is shown in the preset embodiment as including a card account number column 37-1, a mobile link code column 37-2, a PIN code column 37-3, a card status column 37-4, and a user identification column 37-5. As can be appreciated, card status column 37-4 is preferably provided to identify whether a particular card has been activated. Additionally, user identification column 37-5 is preferably provided to identify whether a particular card is to be associated with a certain preregistered user, for reasons to become apparent below.

In the present example, data table 35 is also shown including data for five cards that are designated for use within hybrid system 11. However, it is to be understood that a fewer or greater number of cards could be included in table 35 without departing from the spirit of the present invention. Furthermore, it should be similarly understood that the number and types of columns 37 could also be modified to suit the needs of the particular application.

It should be noted that each card in card status column 37-4 is originally designated as inactive, with the status changing to active upon initial activation of the card at the point-of-sale. Because a card can only be digitally converted when active, the digital conversion of an inactive card may redirect the user to a uniquely designed webpage where the consumer can make a financial transaction in order to activate the card.

### Digital Card Conversion Process within Hybrid System 11

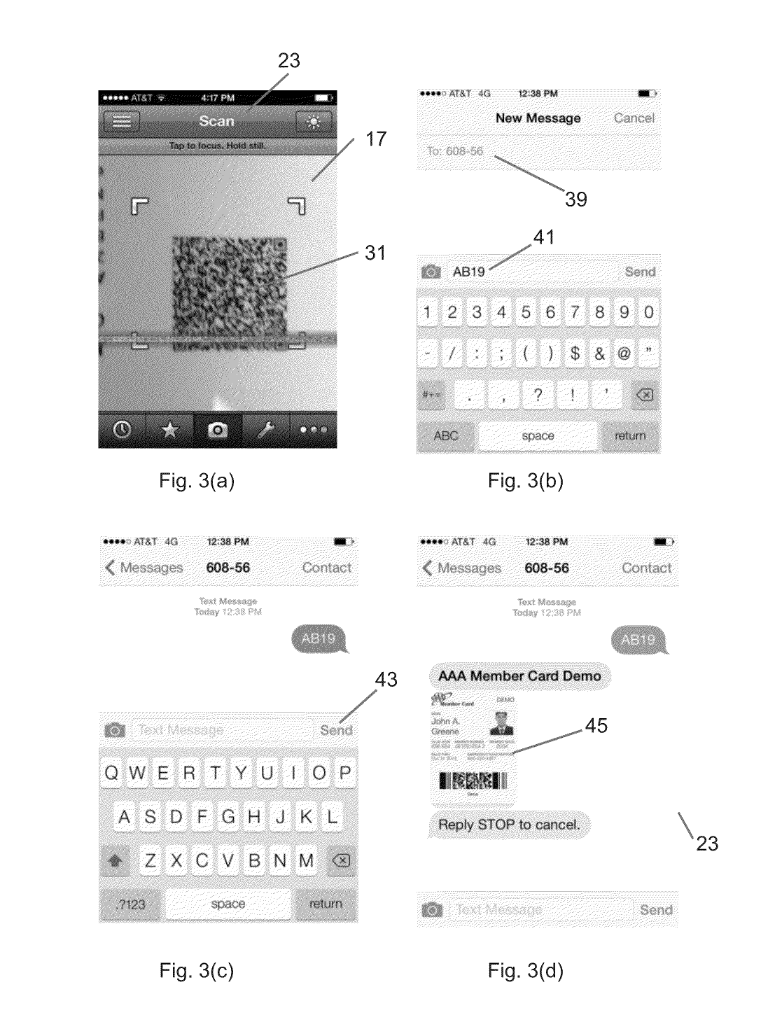

As referenced above, hybrid system 11 allows for a physical stored-value card 17 to be digitally converted into an electronic stored-value card 25 that is integrated within digital stored-value card system 15. Referring now to FIGS. 3(a)-(d), there are shown a series of sample screen displays on mobile device 23 that are useful in understanding the digital card conversion process of the present invention.

Specifically, as shown in FIG. 3(a), the digital card conversion process commences by scanning, or otherwise reading, secondary device 31 using mobile device 23 in order to retrieve the mobile link code associated with physical card 17. In response thereto, mobile device 23 is automatically propagated with the information required to establish electronic communication with card management server 19. For instance, in FIG. 3(b), a screen display of an SMS text window is provided, with the designated server number and mobile link code for card 17 being automatically entered into windows 39 and 41, respectively.

The user can therefore establish an electronic connection between mobile device 23 and card management server 19 and, in turn, initiate a request for digital conversion of physical card 17 by clicking a send, or transmit, button 43 on the text screen, as shown in FIG. 3(c). Once the request is received, card management server 19 first determines whether physical card 17 is active. If inactive, server 19 redirects the user to a transaction page to pay the necessary funds to activate card 17.

Once active, server 19 preferably transmits a user information data input page (e.g., in the form of a webpage or text screen) to mobile device 23 for completion. It is to be understood that the data input page may take any suitable form and may include any useful means to facilitate entering of the required information including, but not limited to, text windows and predefined dropdown boxes.

The type of information requested on the user information data input page is not limited to any particular type of data. The type of information requested may be specified based on the type of card scanned, which can be determined using the card account number. In other words, a card issuer may desire different types of information with respect to one type of stored-value card (e.g., a gift card for a restaurant) than with respect to another type of stored-value card (e.g., a gift card for a sporting goods store). Examples of the type of information that may be required on the user information data input page are provided below. It is to be understood that additional types of data could be requested of the user without departing from the spirit of the invention.

As an example, the user may be requested to input personal contact information, such as a name, email address, and at least one mobile device number. In lieu of providing all of the requested information, the user may simply input a user identification code which can then be used to retrieve from database 21 all the personal information associated with the user that was entered during a previous registration process.

As another example, the user may be requested to enter the PIN code, or a user-created password, if enhanced security is required. It is to be understood that a PIN code would prevent digital card conversion by unauthorized parties who do not physically possess card 17.

As yet another example, the user may be requested to input relevant technical data relating to the particular mobile devices 23 to be associated with the user account (e.g., the operating system, network connection type, secure element (SE) type and/or form factor of device 23). Furthermore, if mobile device 23 supports multiple means for readily storing and accessing data, the selection of a preferred storage means may be requested. In other words, if mobile device 23 is provided with the necessary technical infrastructure to store and retrieve digital card 25 within both a subscriber identity module (SIM) card and a contactless NFC chip), a preferred load method may be requested.

It should be noted that some of the aforementioned technical information relating to user mobile device 23 may be automatically detected by server 19 upon establishing a communication path therewith.

After the requested data has been provided in the user information data input page, the page is transmitted by the user to card management server 19, where it is permanently stored in database 21. Once all the necessary information is received and verified, card management server 19 transmits a digital card file 45 (e.g., a .pkpass file) to mobile device 23 (e.g., via SMS), as shown in FIG. 3(d). Digital card file 45 is then accepted, or opted into, by the user (perhaps automatically). Once accepted by the user, digital card file 45 is downloaded and installed into mobile device 23. As such, the corresponding digital stored-value card 25 is readily available for use through the appropriate software application on mobile device 23, thereby completing the digital card conversion process.

### Features and Advantages of Hybrid Card System 11

The above-described design of hybrid stored-value card system 11 creates a number of notable benefits in the stored-value card industry.

As a first benefit of hybrid system 11, a physical stored-value card 17 is able to be interactively linked with a card management server 19. In this capacity, a direct and continuous communication path is established and maintained between the card owner and the card issuer. As a result, the card owner can engage in a variety of actions with the card issuer including, but not limited to, (i) re-activating the physical card (i.e., elimination of the digital account), if needed, (ii) transferring the digital card balance to another user account (e.g., as a gift to a third party), and (iii) augmenting, or refilling, the balance when needed. At the same, the card issuer is able to engage in a variety of actions with the previously anonymous card owner including, but not limited to, (i) notifying the user of relevant product offerings and sales promotions, and (ii) real-time monitoring of balance information and date of expiration for the card as a service to the card owner.

As a second benefit of hybrid system 11, a physical stored-value card 17 is able to be digitally converted without compromising its stylistic design. In other words, the design attributes (e.g., the background artistry, color scheme and font) of physical stored-value card 17 can be similarly incorporated into the downloadable file sent by server 19 that is used to generate the corresponding digital representation. Because the downloadable file is designed according to the specifications of the card issuer, the stylistic components of the card can be preserved through either medium.

As a third benefit of hybrid system 11, the aforementioned digital card conversion process helps promote industry-wide migration from traditional physical-style cards to electronic-style cards.

It is to be understood that the details of the present invention are intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A hybrid stored-value card system, comprising:
(a) a digital stored-value card system; and
(b) a physical stored-value card system that is selectively electronically linked with the digital stored-value card system, the physical stored-value card system including a physical stored-value card;
(c) wherein the digital stored-value card system is adapted to transform the physical stored-value card into a corresponding electronic stored-value card, the corresponding electronic stored-value card being integrated into the digital stored-value card system.

2. The hybrid stored-value card system as claimed in claim 1 wherein the digital stored-value card system comprises:
(a) a server adapted to transform the physical stored-value card into a corresponding electronic stored-value card; and
(b) a mobile device in electronic communication with the server, the mobile device being adapted to retain the corresponding electronic stored-value card.

3. The hybrid stored-value card system as claimed in claim 2 wherein the physical stored-value card is constructed as a transaction card comprising:
(a) a primary device suitable for storing a first set of automatically retrievable machine-readable data that includes a unique account number for the physical stored-value card; and
(b) a secondary device suitable for storing a second set of automatically retrievable machine-readable data that includes a unique mobile link code that is utilized by the server to transform the physical stored-value card into the corresponding electronic stored-value card.

4. The hybrid stored-value card system as claimed in claim 3 wherein the secondary device is separate from the primary device.

5. The hybrid stored-value card system as claimed in claim 3 wherein each of the primary and secondary devices is a machine-readable data storage device in the form of at least one of the group consisting of a magnetic stripe, a barcode and an integrated circuit chip.

6. The hybrid stored-value card system as claimed in claim 3 wherein the physical stored-value card additionally includes a scratch panel with a PIN code for enhanced security.

7. The hybrid stored-value card system as claimed in claim 3 wherein the digital stored-value card system additionally includes a database in electrical communication with the server.

8. The hybrid stored-value card system as claimed in claim 7 wherein the database stores and cross-references information associated with the physical stored-value card.

9. The hybrid stored-value card system as claimed in claim 8 wherein the information stored and cross-referenced by the database includes the account number, a real-time currency balance and the mobile link code associated with the physical stored-value card.

10. The hybrid stored-value card system as claimed in claim 9 wherein the information stored and cross-referenced by the database additionally includes contact information for a user of the physical stored-value card.

11. The hybrid stored-value card system as claimed in claim 10 wherein the contact information includes at least one of the group consisting of a name, an email address and a mobile number for the user of the physical stored-value card.

12. A method of converting a physical stored-value card into a corresponding electronic stored-value card, the method comprising the steps of:
(a) providing a physical stored-value card that includes a unique mobile link code;
(b) retrieving the unique mobile link code from the physical stored-value card using a mobile device;
(c) transmitting the unique mobile link code from the mobile device to a server in electrical communication therewith;
(d) transforming the physical stored-value card into an electronic stored-value card by the server using the unique mobile link code; and
(e) sending the electronic stored-value card from the server to the mobile device.

13. The method as claimed in claim 12 wherein the retrieving step is accomplished using automated means of data capture.

14. The method as claimed in claim 12 further comprising the step of, prior to the transforming step, submitting user information to the server from the mobile device.

15. The method as claimed in claim 14 wherein the user information includes contact information for a user of the physical stored-value card.

16. The method as claimed in claim 15 wherein the contact information includes at least one of the group consisting of a name, an email address and a mobile number for the user of the physical stored-value card.

17. The method as claimed in claim 16 wherein the user information includes technical data relating to the mobile device.

18. The method as claimed in claim 12 wherein, after the sending step, the electronic stored-value card is downloaded and installed onto the mobile device.
